(19) United States
(12) Patent Application Publication
(10) Pub. No.: US 2020/0235352 A1
(43) Pub. Date: Jul. 23, 2020

(54) BATTERY CASE AND BATTERY

(71) Applicant: SAMSUNG ELECTRONICS CO., LTD., Suwon-si (KR)

(72) Inventors: Moon Il JUNG, Suwon-si (KR); Junghoon LEE, Seongnam-si (KR); Ginam KIM, Seongnam-si (KR); Sung Dug KIM, Suwon-si (KR); In KIM, Suwon-si (KR); Moo Ho LEE, Suwon-si (KR)

(21) Appl. No.: 16/747,132

(22) Filed: Jan. 20, 2020

(30) Foreign Application Priority Data
Jan. 21, 2019 (KR) 10-2019-0007793

(51) Int. Cl. H01M 2/04; B60L 50/64; H01M 2/02; B29C 59/14; H01M 10/052

(52) U.S. Cl. CPC H01M 2/0434; B60L 50/64; H01M 2220/20; B29C 59/142; H01M 10/052; H01M 2/0262

(57) ABSTRACT

A battery case including a container having an opening and a sink configured to accommodate an electrode, and a cover having a contact portion configured to contact with the container. The battery case includes a polymer base material, the container includes a bottom wall and side walls, that are integrated to form the sink and the opening opposed to the bottom wall. A nanometer-size concavo-convex edge feature is positioned on at least one portion of the end face of the side walls configured to form the opening and on at least one portion of the contact surface of the contact portion of the cover configured to contact with at least one portion of the end face of the sidewalls of the container. A battery or a battery module including the battery case and an electrode assembly accommodated in the sink of the container of the battery case.

### CROSS-REFERENCE TO RELATED APPLICATION

This application claims priority to Korean Patent Application No. 10-2019-0007793 filed in the Korean Intellectual Property Office on Jan. 21, 2019, and all benefits accruing therefrom under 35 U.S.C. § 119, the entire content of which is herein incorporated by reference.

### BACKGROUND

### 1. Field

This disclosure relates to a battery case and a battery.

### 2. Description of the Related Art

Research on an electric vehicle (EV) using at least one battery system to supply a part of or an entire part of motive power for the EV is of active interest. The electric vehicle exhibits greater fuel efficiency, e.g., a hybrid EV, and discharges lower emissions and less contamination to the environment compared with a traditional vehicle operated with an internal combustion engine. Some EVs use no gasoline at all or obtain entire motive power from electricity, e.g., from an electric battery. As research on EVs continues to progress, a requirement for an improved motive power source for the electric vehicle, for example, an improved battery module is of increasing interest.

An EV using electricity for as at least a part of motive power may obtain electricity from a plurality of individual battery cells arranged or packed as a battery module. For example, the plurality of lithium ion battery cells or cell elements may include the battery module. To achieve top performance lithium ion battery cells or cell elements and the battery module including a combination thereof are operated at ever higher temperatures, and therefore, may be packed with a material for cooling. In addition, the lithium ion battery elements are particularly sensitive to oxygen or moisture, and thus, packed in a moisture-sealing metal housing. unfortunately, present metal housings have design limitations in term of shape due to restrictions with metal manufacture. Accordingly, a battery case and a method of manufacturing a battery module capable of solving issues of heat management, moisture transmission, and being manufactured at relatively low cost or high production efficiency is needed.

### SUMMARY

An embodiment provides a battery case having improved moisture transmission resistivity.

Another embodiment provides a battery including an electrode assembly housed in the battery case.

A battery case according to an embodiment includes a container having an opening and a sink configured to accommodate an electrode assembly having a positive electrode and a negative electrode, and a cover having a contact portion in contact with the container to cover the opening of the container, wherein at least one of the container or the cover comprises a polymer base material. The container includes a bottom wall and side walls, the bottom wall and the side walls are integrated to form the sink and the opening opposed to the bottom wall, and a nanometer-size concavo-convex edge feature is positioned on at least one portion of the end face of the side walls configured to form the opening and on at least one portion of the contact surface of the contact portion of the cover configured to contact at least one portion of the end face.

The nanometer-size concavo-convex edge feature may be formed by plasma treatment.

The plasma treatment may be performed in the presence of argon, oxygen, or a mixture thereof.

The nanometer-size concavo-convex edge feature may have a ratio of a depth with reference to a width of greater than or equal to 20 percent. The nanometer-size concavo-convex edge feature may have a width of about 10 nanometers (nm) to about 100 nm and a depth of about 2 nm to about 50 nm.

The at least one portion of the end face of the side walls or the at least one portion of the contact surface of the contact portion of the cover configured to contact at least one portion of the end face may have a water contact angle of less than about 5 degrees.

In one embodiment, a millimeter-size recess portion and corresponding protrusion configured to engage each other may be further positioned on at least one portion of the end face of the side walls configured to form the opening and on at least one portion of the contact surface of the contact portion of the cover configured to contact at least one portion of the end face, respectively.

The millimeter-size recess portion and corresponding protrusion may have a right triangular shape in their vertical cross-section. The millimeter-size recess portion proximate to the sink of the container may recede perpendicularly into the side walls to a set depth. Moreover, the opening proximate to the outside of the case, may have a height that gradually decreases to the set depth and thereby forms an oblique shape in the vertical cross-section. The millimeter-size corresponding protrusion may have a shape corresponding to the millimeter-size recess portion to engage each other.

A nanometer-size concavo-convex edge feature may also be positioned on the oblique surface of the recess portion and/or on the oblique surface of the corresponding protrusion.

The container may further include at least one partition wall that divides the inside of the sink into two or more spaces.

The polymer base material may include a polymer including polycarbonate, polyethylene, polypropylene, polyvinyl, polyamide, polyester, polyphenylene sulfide (PPS), polyphenylene ether, polyphenylene oxide, polystyrene, polyamide, a polycyclic olefin copolymer, an acrylonitrile-butadiene-styrene copolymer, a liquid crystal polymer (LCP), a mixture thereof, an alloy thereof, or a copolymer thereof.

The polymer base material may further include an inorganic moisture absorber dispersed in the base material. The inorganic moisture absorber may include a silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂, Ba(ClO₄)₂, Ca, or a combination thereof.

The polymer base material may further include a moisture barrier material dispersed in the base material. The moisture barrier material may include graphite, wollastonite, mica, whisker, barium sulfate, kaolin, talc, nanoclay, a carbon fiber, a glass fiber, or a mixture thereof.

The container and the cover may be made by a molding process, and each may have the same or a different base polymer material.

The battery case may have a water vapor transmission rate (WVTR) of less than 0.05 grams per square meter per day (g/m²/day) measured at a thickness of 1 mm, at 38° C. under relative humidity of 100% according to ISO 15106 or ASTM F1249.

A battery according to another embodiment includes the battery case according to the embodiment and an electrode assembly including a positive electrode and a negative electrode accommodated in a sink of the battery case.

The battery may further include an electrolyte solution in the sink of the container of the battery case.

The electrode assembly may be an electrode assembly for a rechargeable lithium battery.

The container and the cover of the battery case may be adhered by an adhesive upon closure of the case.

The battery case according to an embodiment includes the container configured to accommodate an electrode assembly and the cover for covering the opening of the container. The container may be made of a polymer base material, and include a nanometer-size concavo-convex edge feature positioned on contact surfaces of the container and/or the cover, thereby providing high adherence when the container and the cover are adhered with or without an adhesive. Accordingly, permeation of external moisture or air (oxygen) into the battery case may be effectively suppressed or reduced through the interface of the cover with the container. In addition, the polymer base material may further include an inorganic moisture absorber and/or a moisture barrier material, and thus, further increase the moisture transmission resistivity of the battery case. The polymer base material may be molded into various battery cases having a desired shape and size at relatively low cost, and these battery cases have high moisture transmission resistivity. The battery case may be used for a rechargeable lithium battery requiring moisture transmission resistivity such as a rechargeable lithium battery.

### BRIEF DESCRIPTION OF THE DRAWINGS

FIG. 1 is a schematic exploded perspective view showing a battery case according to an embodiment.

FIG. 2 is a schematic vertical direction cross-sectional view showing the battery case shown in FIG. 1.

FIG. 3 is a view enlarging a portion marked by a circle in FIG. 2.

FIG. 4 is a view enlarging a contact portion shown in FIG. 3, showing a convex portion 10 on a contact surface 6a of a cover 5, and a recess portion 11 on end faces 3a of side walls 3 according to another embodiment.

FIG. 5 is a schematic perspective view showing a battery case according to another embodiment.

FIG. 6 is a SEM (scanning electron microscope) photograph showing the surface of an article of a liquid crystal polymer before a plasma treatment.

FIG. 7 is a SEM photograph showing the surface of the article of a liquid crystal polymer of FIG. 6 following the plasma treatment.

FIG. 8 is a photograph showing water contact angle measurement of the liquid crystal polymer before and after the plasma treatment.

FIG. 9 is a graph showing a tensile lap-shear strength of each specimen after adhering two panels formed of aluminum (Al) and a liquid crystal polymer (LCP) and two panels all formed from the liquid crystal polymer (LCP) using different surface plasma treatments or no surface plasma treatment.

FIG. 10 is a photograph showing a fractured section state of each specimen shown in FIG. 9 following a fracture of each specimen.

### DETAILED DESCRIPTION

Hereinafter, embodiments are described in detail with reference to drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

If not defined otherwise, all terms (including technical and scientific terms) in the specification may be defined as commonly understood by one skilled in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms defined in a generally-used dictionary may not be interpreted ideally or exaggeratedly unless clearly defined.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the drawings, the thickness of each element is exaggerated for better comprehension and ease of description. It will be understood that when an element such as a layer, film, region, or plate is referred to as being “on” another element, it can be directly on the other element or intervening elements may also be present. In contrast, when an element is referred to as being “directly on” another element, there are no intervening elements present.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

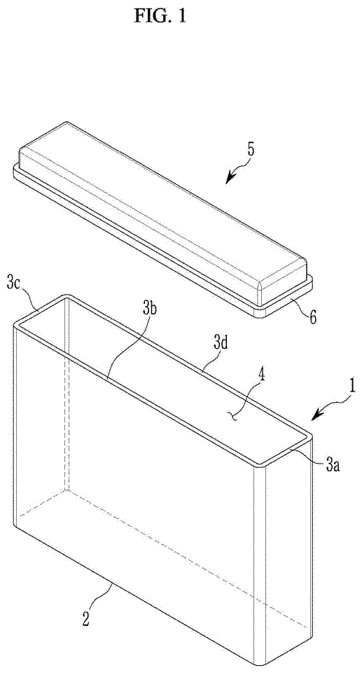

FIG. 1 is a schematic exploded perspective view of the battery case according to an embodiment. A battery case includes a container 1 configured to accommodate an electrode assembly and a cover 5 to cover an opening of the container 1. The container 1 includes a bottom wall 2 and side walls 3 and the side walls and the bottom wall are integrated to form a sink 4, which is the interior space configured to accommodate an article, and an upper opening opposed to the bottom wall 2.

Herein, “integrated” means that the bottom wall 2 and the side walls 3 are connected each other, so that other portions except the opening may provide a closed space. This integrating method is not particularly limited but, as described later, may for example include a method of molding a polymer base material or a composite material including the polymer base material, an inorganic moisture absorber, and the like, as one step into a battery case configured to accommodate an electrode assembly, in which the bottom wall 2 and the side walls 3 are integrated, or a method of separately molding the bottom wall 2 and a plurality of the side walls 3 into each battery case and connecting them into an integrated shape through a publicly-known bonding method such as welding, adhesion, and the like. As shown above, the integrating method is not limited thereto but may include various methods known to those who have an ordinary skill in the related art to integrate the bottom wall 2 and the side walls 3 and thus form a battery case configured to accommodate an electrode assembly.

The cover 5 may have a contact portion 6 configured to contact with end faces 3a to 3d of the side walls 3 forming an opening of the container. Accordingly, the end faces 3a to 3d of the side walls 3 may contact the contact surface of the contact portion 6 of the cover 5 to close the opening of the container. In an embodiment, the end faces 3a to 3d of the side walls and the contact surface of the contact portion 6 of the cover 5 adhere to each other to close and seal the opening.

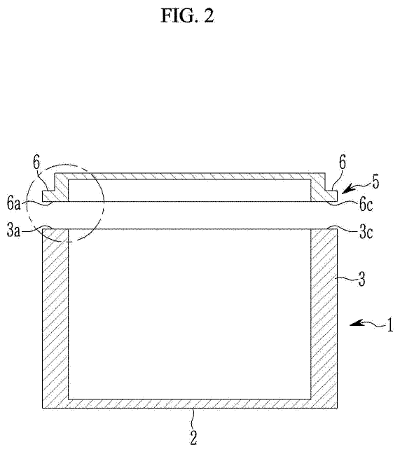

FIG. 2 is a schematic vertical direction cross-sectional view showing the battery case shown in FIG. 1. However, for better comprehension and ease of description, FIG. 2 exaggeratively shows thicknesses of the bottom wall 2 and the side walls 3 of the container 1 and widths of contact surfaces 6a and 6c of the contact portion 6 of the cover 5 which are shown in FIG. 1. Herein, a thickness ratio of the bottom wall 2 and the side walls 3 may not correspond with that of FIG. 1. In addition, the end face 3a or 3c of the side walls 3 of the container 1 and the contact surface 6a or 6c of the contact portion 6 of the cover 5 are shown to have the same thickness but do not necessarily have the same thickness, and a width of the contact surface 6a of the cover 5 may be larger or smaller than a thickness of the side wall 3, that is, a width of the end face 3a of the side wall 3. In an embodiment, the width of the contact surface 6a may be the same as the width of the end face 3a of the side wall 3.

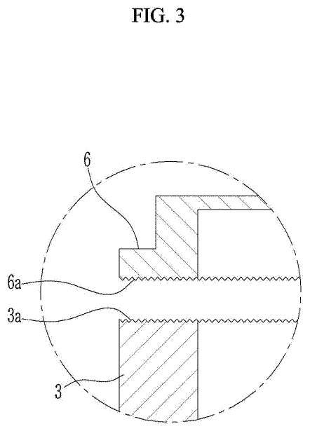

FIG. 3 is a view enlarging a portion marked by a circle in FIG. 2, that is, the contact portion 6 of the cover 5 and the end face 3a of the side wall 3 of the container 1.

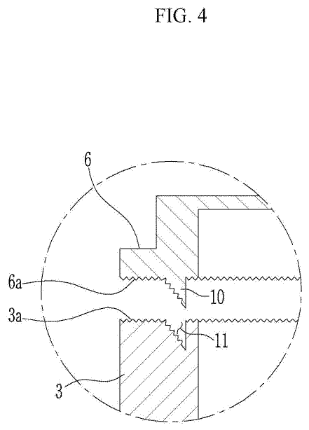

Referring to FIG. 3, a relatively small concavo-convex edge feature is positioned along a horizontal surface of the end face 3a of the side wall and a horizontal surface of the contact surface 6a of the contact portion 6 of the cover 5. The small concavo-convex edge feature includes a nanometer-size pattern. As depicted in FIGS. 3 and 4, this nanometer-size pattern is represented as a saw-tooth pattern however, the nanometer size pattern is not limited to such a pattern. Again, the depicted saw-tooth pattern is merely representative of a surface that can be formed following a plasma treatment infra. For example, the nanometer-size concavo-convex edge feature may have a width ranging from about 10 nanometers (nm) to about 100 nm and a depth ranging from about 2 nm to about 50 nm. In other words, the concavo-convex edge feature having a nanometer-size width and depth are positioned on a portion where the container 1 and the cover 5 of the battery case according to an embodiment contact each other and specifically, on the end face 3a of the side wall 3 of the container 1 and on the contact surface 6a of the contact portion 6 of the cover 5. This nanometer-size concavo-convex edge feature may be formed with a plasma treatment of the end face 3a of the side wall 3 of the container 1 and the contact surface 6a of the contact portion 6 of the cover 5. The plasma treatment may be performed by using argon, oxygen, or a mixture thereof, for example, the nanometer-size concavo-convex edge feature may be formed by using an argon gas or a mixed gas of argon and oxygen. If argon gas is used, a depth of the concavo-convex edge feature may be large, and if oxygen is used, a width of the concavo-convex edge feature may be large.

FIG. 4 is a view enlarging the portion marked by a circle in FIG. 2, but according to another embodiment, the nanometer sized concavo-convex edge feature is not only positioned on the end face 3a of the side walls 3 of the container 1 and the contact surface 6a of the contact portion 6 of the cover 5 as shown in FIG. 3, but also on a protrusion 10 having an inverted right triangle cross-section located on the contact surface 6a of the cover 5, and a corresponding recess portion 11 receded into the side wall 3 as an inverted right triangle shape located on the end face 3a of the side wall 3. The protrusion 10 and the corresponding recess portion 11 have cross-sections engaging each other. Accordingly, when the cover 5 is put together with the container 1 to close the opening, the protrusion 10 may be inserted into the recess portion 11 and engage therewith.

As shown, the protrusion 10 may form a perpendicular edge with the contact surface 6a of the cover 5 proximate to the sink 4 of the container 1 of the battery case, but the protrusion thereof from the contact surface 6a gradually decreases away from the sink 4 and toward the outside of the battery case. Accordingly, the protrusion 10 has a right triangle cross-section. The recess portion 11 corresponds to the shape of the protrusion 10, and recedes long inside the side walls 3 perpendicularly to the end face 3a of the side walls 3. To engage the protrusion 10 the recess portion 11 extends to a set depth proximate to the sink 4 of the container 1, and the recess depth gradually decreases into the side walls 3 further away from the sink 4 and toward the outside of the battery case. Accordingly, the recess portion 11 also has a right triangle cross-section. The protrusion 10 and the recess portion 11 will be of millimeter-size and may be formed together with the container 1 and the cover 5 as the container 1 and the cover 5 are manufactured in a method of molding and the like. In an aspect, the millimeter-size recess portion and corresponding protrusion have a right triangular shape in their vertical cross-section, wherein the recess portion proximate to the sink recedes near perpendicularly into a side wall to a set depth and has a depth that gradually decreases from the set depth as the recess approaches the outside of the container to form an oblique shape in the vertical cross-section, and wherein the corresponding protrusion has a shape corresponding to the recess portion to engage each other.

In addition, a concavo-convex edge feature also may be positioned on an oblique portion on a length of the cross-section of the protrusion 10 and the corresponding recess portion 11. This concavo-convex edge feature may have the same nanometer size as that of the end face 3a of the side wall 3 and the contact surface 6a of the cover 5. Accordingly, this concavo-convex edge feature may not be formed together when the protrusion 10 and recess portion 11 are formed, but instead, formed by plasma surface-treating the surfaces of the protrusion 10 and the recess portion 11 after molding the container 1 and the cover 5 including the protrusion 10 and the recess portion 11. The plasma surface treatment is the same as described above.

As aforementioned, the battery case according to an embodiment includes a nanometer-size concavo-convex edge feature on contact portions of the container 1 and the cover 5, for example, on the end face 3a of the side wall 3 of the container 1 and on the contact surface 6a of the contact portion 6 of the cover 5. Accordingly, if the container 1 and the cover 5 are adhered by putting an adhesive therebetween, an adhesion area is increased, and thus adherence may be greatly increased. This increased adherence may firmly adhere the cover 5 to the container 1, which may effectively suppress permeation of external air or moisture into the battery case through the adhered interface of the container and the cover. Accordingly, moisture transmission resistivity of the battery case may be increased.

In addition, if the container 1 and the cover 5 are bonded by applying an adhesive between the contact surface 6a of the contact portion 6 of the cover 5 and the end face 3a of the side wall 3 of the container 1, the protrusion 10 and the recess portion 11 may play a role of preventing the applied adhesive from overflowing into the sink 4 of the container 1. As shown in FIG. 4, the protrusion 10 and the recess portion 11 have an angular or oblique cross-section with a sharp vertical edge proximate to the sink of the container 1, and therefore, if the protrusion 10 and the recess portion 11 are bonded by applying an adhesive between the contact surface 6a and the end face 3a, an adhesive overflowing from the adhered surface may flow down along an oblique bonding surface of the protrusion 10 and the recess portion 11. The longest cross-sections of the protrusion 10 and the recess portion 11 are extended perpendicularly to the contact portion and bonded together and thus prevent the adhesive from passing the bonded sections. Accordingly, when the container 1 and the cover 5 further include the protrusion 10 and the recess portion 11 having the aforementioned cross-sections along with a nanometer-size concavo-convex edge feature positioned where the container 1 contacts the cover 5, the adhesive may be prevented from overflowing into the sink 4 and thus contaminating an article or a material accommodated therein.

In addition, if the protrusion 10 and the recess portion 11 have the aforementioned cross-sections, the material in the sink 4 of the container 1 may be prevented from escaping over the side walls 3 of the container 1, i.e., of the sink 4. In other words, the protrusion 10 and the recess portion 11 have the aforementioned cross-sections and thus an effect of effectively suppressing or reducing the material from escaping the sink as well as preventing an external material from entering the sink. Moreover, the presence of the nanometer sized concavo-convex edge feature positioned on the oblique cross-section of the protrusion 10 and the recess portion 11 may result in stronger adherence of the protrusion 10 and the recess portion 11.

In addition, a battery case including the container 1 and the cover 5 having a parallelepiped shape is exemplarily illustrated here but not limited thereto and may have various sizes and shapes depending on usage or a purpose. For example, in FIG. 1, the bottom wall 2 of the container 1 has a rectangular shape, and the side walls 3 of the container 1 may consist of four side walls perpendicularly extended along each edge of the rectangular bottom wall 2, but if the bottom wall 2 has a round shape, the side walls 3 may be formed as one wall connected along the circumference of the bottom wall 2 for example in the shape of a cylinder or an oval or oblong shaped cylinder. In this way, the battery case according to an embodiment is formed from the polymer base material and thus may be easily manufactured to have a desired shape and size using well-known methods in the related art such as molding and the like.

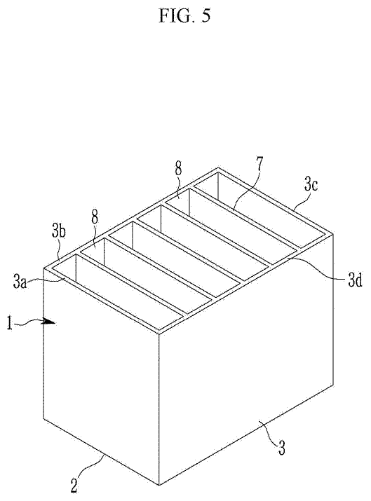

In addition, the container 1 of FIG. 1 includes only one sink 4, but as shown in FIG. 5, the sink 4 inside the container 1 may be partitioned into a plurality of compartments 8. Herein, the container 1 includes at least one partition wall 7 inside the sink 4 to partition the sink 4 into at least two compartments 8.

As aforementioned, the battery case according to an embodiment is formed of the polymer base material and thus may not only manufactured to have a desired size or shape, but also the container 1 and the cover 5 may be easily bonded and sealed by using an adhesive. In order to increase the adherence between the container 1 and the cover 5, a nanometer-size concavo-convex edge feature may be positioned on the contact surfaces 6a to 6d of the contact portion 6 of the cover and the end faces 3a to 3d of the container side walls 3. Accordingly, a contact area is increased and surface roughness is increased, thereby, hydrophobic surface characteristics of the polymer base article are changed into hydrophilic surface characteristics and the adherence may be further increased.

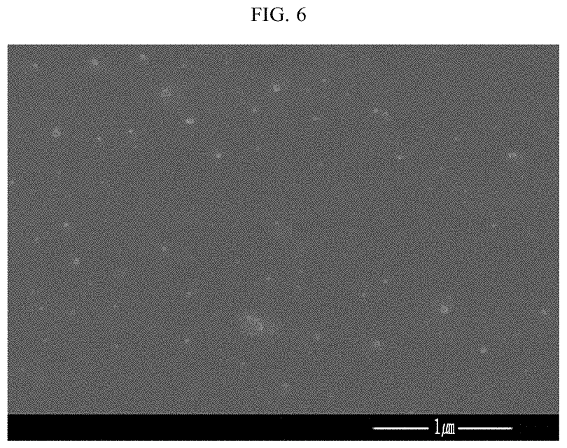

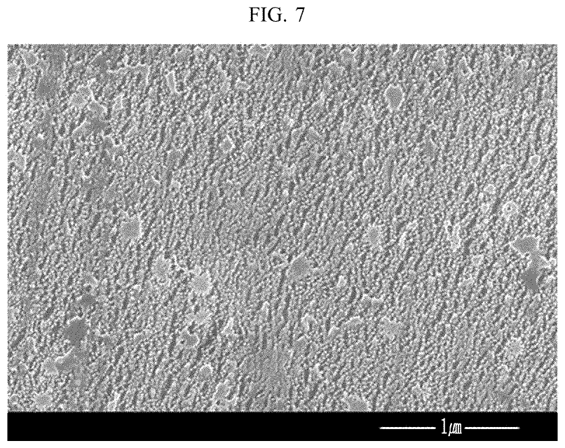

FIG. 6 is a scanning electron microscope (SEM) photograph showing the surface of an article molded from a liquid crystal polymer as the polymer base material before a plasma treatment. FIG. 7 is a scanning electron microscope (SEM) photograph showing the surface of the same article after the plasma treatment using argon gas. FIG. 6 shows that the article has a smooth surface without a large defect, but FIG. 7 shows that a relatively uniform concavo-convex edge feature is formed on the surface of the article and forms a roughened surface.

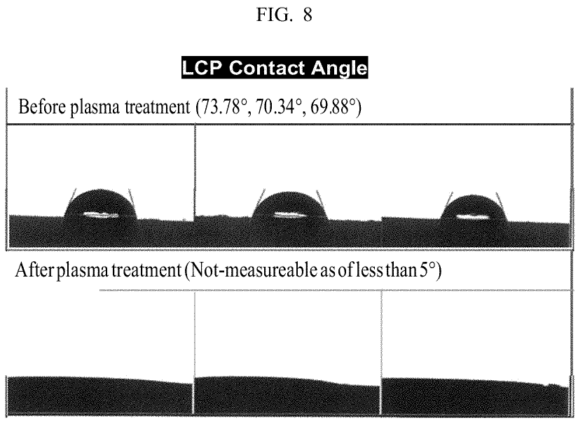

FIG. 8 is a photograph showing results of contact angles measured by dropping water on the surface of the articles molded from the liquid crystal polymers (LCP). In FIG. 8, three top row photographs show each water drop formed on the surfaces of three articles made of the same liquid crystal polymer by respectively dropping water in the same method and each surface contact angle of the water drops, and three bottom row photographs of FIG. 8 show each surface contact angle of water drops on the surfaces of the articles after a plasma treatment by using argon gas.

As shown in the top three photographs of FIG. 8, the water contact angles of the three articles before the plasma treatment are respectively 73.78 degrees, 70.34 degrees, and 69.88 degrees, which are very high, and accordingly, the articles have a very hydrophobic surface. On the other hand, in the bottom row photographs of FIG. 8, water is dropped on the same articles after the plasma treatment, but all the three articles do not properly maintain a water drop shape, and accordingly, a surface contact angle thereof is difficult to measure. As shown in the photographs, the same articles after the plasma treatment using argon gas show a surface contact angle of less than about 5 degrees.

In this way, the surface of the article made from the polymer base material according to an embodiment is changed from hydrophobic characteristics into hydrophilic characteristics through the plasma treatment, and accordingly, affinity for the adhesive may not only be improved, but also the surface area is increased, and thus adherence is greatly increased.

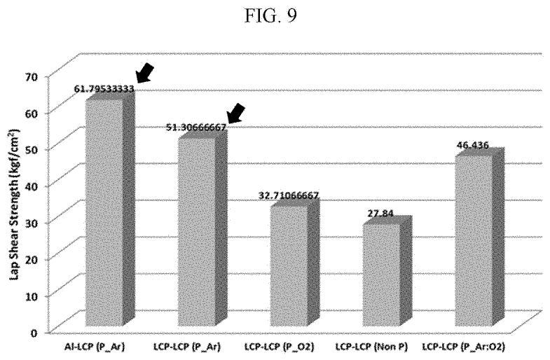

Experiments of directly showing this adhesion increase effect are performed by manufacturing two panels of aluminum (Al) and a liquid crystal polymer (LCP), or two panels of the liquid crystal polymer (LCP). The respective pairs of panels are adhered to each other by using an adhesive in a surface treatment state by using various gases or in a non-surface treatment state, and measuring tensile lap-shear strength of each specimen by using ISO 4587. The adhesion results are shown as a bar graph in FIG. 9.

As shown in FIG. 9, as for an aluminum panel and a liquid crystal polymer panel, each of which is plasma surface-treated under argon gas and adhered (Al-LCP(P_Ar)), the highest tensile lap-shear strength is obtained. If two of the same liquid crystal polymer panels are adhered after plasma surface-treated under argon gas (LCP-LCP(P_Ar)), the next highest tensile lap-shear strength is obtained. If two of the same liquid crystal polymer panels adhered under a mixed gas of argon gas and oxygen (LCP-LCP(P_Ar:O₂)) another tensile lap-shear strength is indicated. The same two liquid crystal polymer panels adhered under oxygen (LCP-LCP P_O₂) provide another tensile lap-shear strength. The same two liquid crystal polymer panels adhered without a plasma surface treatment (LCP-LCP(Non P)) shows the lowest tensile lap-shear strength.

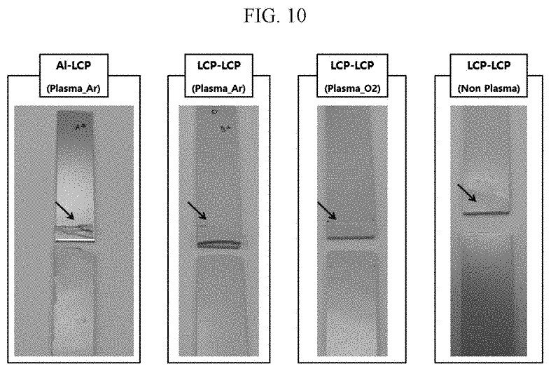

In addition, FIG. 10 shows a fractured section state of each specimen manufactured in accordance with the experiments associated with FIG. 9. In FIG. 10, as for the specimen (Al-LCP(Plasma_Ar)) adhered by an adhesive after plasma-treating the aluminum panel and the liquid crystal polymer panel under argon gas, the liquid crystal polymer panel is not completely separated from the aluminum panel but partially remains there. In addition, as for the specimen (LCP-LCP(Plasm_Ar)) adhered by an adhesive after plasma-treating the liquid crystal polymer panels under argon gas, one liquid crystal polymer panel is not completely separated from the other liquid crystal polymer panel in the adhered section. In contrast, for the specimen (LCP-LCP(Plasm_O₂)) adhered by an adhesive after plasma-treating the liquid crystal polymer panels under oxygen, one liquid crystal polymer panel is shown to be completely separated from the other liquid crystal polymer panel at the adhered section, and the used adhesive partially remains on the adhered section. Lastly, as for the specimen (LCP-LCP(Non Plasma)) adhered without a plasma treatment of the liquid crystal polymer panels, as like the specimen (LCP-LCP(Plasm_O₂)) plasma-treated under oxygen gas, one liquid crystal polymer panel is completely separated and easily detached from the other liquid crystal polymer panel, and the used adhesive partially remains on the adhered section.

In summary, if articles manufactured from the polymer base material such as the liquid crystal polymer are adhered by using an adhesive, adherence may be greatly increased by adhering them after plasma-treating the surfaces of the articles. As described above, when two articles manufactured by using the polymer base material are adhered by using an adhesive, a bonding force between two articles is increased, and an excellent close-contacting force is obtained. Accordingly, permeation of external moisture or air and the like through the interface between the two articles may be sufficiently reduced or minimized. Accordingly, when a nanometer-size concavo-convex edge feature is positioned on the adhered surface through a plasma surface treatment according to an embodiment, adherence improvement and excellent moisture transmission resistivity may be achieved.

Accordingly, the battery case according to an embodiment may be used to accommodate various electrode assembly requiring moisture transmission resistivity. The battery case according to an embodiment may be usefully used to encapsulate the electrode assembly accommodated therein.

Research on electric vehicles (EV) using at least one battery system to supply a part or entire part of a motive power is of active interest. Some of these electric vehicles do not use gasoline at all, or they get the entire power from electric power. As research on the electric vehicles moves forward, the demand for an improved power source, for example, an improved battery or battery module will also increase.

A rechargeable lithium battery capable of being charged and discharged and having high energy density, that is, an electrochemical device such as battery for these electric vehicles is of great interest and need. However, present rechargeable lithium batteries have a problem of performance degradation of electrodes due to generation of hydrofluoric acid (HF) when moisture penetrates into the battery case. In order to prevent or minimize moisture penetration, an aluminum material having improved moisture transmission resistivity is mainly used as a case for the rechargeable lithium battery. That is, an electrode assembly including positive and negative electrodes is inserted into a case such as an aluminum pouch and an aluminum can and sealed to make a battery cell, and a plurality of the battery cells is used to form a battery module. Unfortunately, this method and design requires a complicated assembly process, relatively large amount of fabrication time and high cost, and therefore, changes in manufacturing processes need to be improved. That is, research on realizing a cell-module integrated structure without forming a separate battery cell after forming the electrode assembly is one solution. However, in order to realize this cell-module integrated structure, mechanical strength, moisture transmission resistivity, and the like need to be considered and improved, if possible

A battery case formed of a conventional metal has a limited shape due to a limit in terms of a metal manufacture technology, a battery case having a desired shape and/or size requires a multistep process, a high cost, and relatively long or inefficient time of production. In addition, the metal case due to the weight of the metal itself and if a plurality of sinks is included in order to house a plurality of battery cells, the increase in weight and costs increase proportionately. Accordingly, a need for an efficient battery case and a battery using the same capable of solving a problem of heat management, moisture transmission, and the like and having a low manufacturing cost are described herein.

The battery case according to an embodiment may be easily molded to have a desired size and shape by using a light and inexpensive polymer base material, including the container 1 and the cover 5 configured to accommodate an electrode assembly. Moreover, an electrode assembly may be accommodated by inserting an electrode assembly in the sink 4 of the container 1 through an opening of the container 1, and then, covering and closing the opening with the cover 5. In addition, since a nanometer-size concavo-convex edge feature is positioned where the container 1 and the cover 5 contact, the container 1 and the cover 5 may be adhered and sealed by applying an adhesive where the nanometer-size concavo-convex edge feature is positioned. Accordingly, the battery case can reduce or minimize penetration of external moisture or air (oxygen) into the battery assembly or cells. As described above, when the nanometer-size concavo-convex edge feature is positioned on the adhered section, adhesion strength is greatly increased compared to a similar container and cover design in the absence of the concavo-convex edge feature. Accordingly, excellent mechanical properties may not only be obtained, but also permeation of moisture and air through the interface of the container 1 and the cover 5 may be substantially reduced or minimized.

To improve upon the moisture transmission resistivity and mechanical properties of the battery case, a known polymer having improved moisture transmission resistivity and mechanical properties may be used as a primary base material. For example, the polymer may include polycarbonate, polyethylene, polypropylene, polyvinyl, polyamide, polyester, polyphenylene sulfide (PPS), polyphenylene ether, polyphenylene oxide, polystyrene, polyamide, a polycyclic olefin copolymer, an acrylonitrile-butadiene-styrene copolymer, liquid crystal polymer (LCP), a mixture thereof, an alloy thereof, or a copolymer thereof, but is not limited thereto.

In an embodiment, as for the polymer base material, a liquid crystal polymer (LCP) or high density polyethylene (HDPE) which is known to have excellent mechanical properties and moisture transmission resistivity may be particularly used but is not limited thereto.

In an embodiment, the liquid crystal polymer may be prepared by polymerizing hydroxybenzoic acid/or polymerizing various aromatic hydroxycarboxylic acids and/or aromatic dicarboxylic acids with an aromatic diol other than the hydroxybenzoic acid.

In an embodiment, the polymer may further include a fluorinated resin in addition to the polymer that is the primary base material. The fluorinated resin is of hydrophobic character, and thus, if the fluorinated resin is included in an amount of less than or equal to about 20 weight percent (wt %), for example, less than or equal to about 15 wt %, less than or equal to about 10 wt %, for example, about 3 wt % to about 10 wt %, for example, about 5 wt % to about 10 wt %, based on a total weight of the polymer, an article produced therefrom can reduce or minimize the transmission of moisture from the surface of the article that is in contact with the outside air. The fluorinated resin may include polytetrafluoroethylene (PTFE), polyvinylidene fluoride (PVDF), polychlorotrifluoroethylene (PCTFE), mixture thereof, or a copolymer thereof, but is not limited thereto.

Although the liquid crystal polymer or the high density polyethylene is used alone, or the fluorinated resin is added thereto, polymer materials alone may not secure high moisture transmission resistivity like that of a metallic material battery case. Accordingly, the battery case according to an embodiment may be manufactured from a composite material that further includes an inorganic moisture absorber dispersed in the polymer material. If the battery case according to an embodiment is manufactured from a composite material including a liquid crystal polymer or high density polyethylene as a polymer material and the inorganic moisture absorber in an amount of less than or equal to about 30 wt %, based on a total weight, a water vapor transmission rate (WVTR) of less than about 0.05 gram per square meter per day (g/m²/day) measured at a thickness of about 1 mm at about 38° C. under relative humidity of about 100% according to ISO 15106 or ASTM F1249 may be achieved.

The inorganic moisture absorber may include at least one of a silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂, Ba(ClO₄)₂, Ca, or a combination thereof, but is not limited thereto.

In an embodiment, the inorganic moisture absorber may include zeolite, CaO, MgO, or a combination thereof.

Zeolite having various pore sizes is commercially available, and when the battery case according to an embodiment includes zeolite as an inorganic moisture absorbent, the zeolite may have a pore size ranging from about 3 Angstroms (Å) to about 10 Å, for example, about 3 Å to about 8 Å, about 3 Å to about 7 Å, or about 3 Å to about 5 Å. Because a water molecule has a size of about 3.8 Å, the water molecule may be easily trapped in the pore of the zeolite. In addition, the zeolite may have an average particle diameter ranging from about 2 micrometers (μm) to about 10 μm, and include aluminum in an amount of greater than or equal to about 40 wt %. If an amount of aluminum in the zeolite is within the range, excellent hygroscopicity may be exhibited.

If the inorganic moisture absorbent is CaO, a particle size of CaO may be about 0.1 μm to about 1 μm, for example, about 0.1 μm to about 0.9 μm, about 0.1 μm to about 0.8 μm, about 0.1 μm to about 0.7 μm, about 0.1 μm to about 0.6 μm, about 0.1 μm to about 0.5 μm, about 0.1 μm to about 0.4 μm, about 0.2 μm to about 0.5 μm, or about 0.2 μm to about 0.4 μm.

Zeolite is a physical moisture absorbent absorbing water through a particle having a pore, while CaO is a chemical water adsorbent adsorbing water through a chemical reaction with a water molecule. Accordingly, in an example embodiment, as the inorganic moisture absorbent, zeolite and CaO may be used together, and thereby a battery case manufactured therefrom may have a further reduced water vapor transmission rate.

The inorganic moisture absorbent may be included in an amount of less than or equal to about 30 wt %, for example, about 1 wt % to about 30 wt %, about 2 wt % to about 30 wt %, about 3 wt % to about 30 wt %, about 3 wt % to about 25 wt %, about 5 wt % to about 25 wt %, about 5 wt % to about 20 wt %, about 10 wt % to about 25 wt %, or about 10 wt % to about 20 wt % based on a total weight of the article, but is not limited thereto.

The battery case consisting of the polymer not including the inorganic moisture absorber may have a water vapor transmission rate (WVTR) of less than or equal to about 0.5 g/m²/day measured at a thickness of 1 mm, at 38° C. under relative humidity of 100% according to ISO 15106 or ASTM F1249. However, the battery case manufactured from the composite material including the polymer and the inorganic moisture absorber within the stated amount range, for example, the battery case may have a very low water vapor transmission rate measured at a thickness of 1 mm, at 38° C. under relative humidity of 100% according to ISO 15106 or ASTM F1249 of less than about 0.05 g/m²/day, for example, less than about 0.045 g/m²/day, less than or equal to about 0.040 g/m²/day, less than or equal to about 0.035 g/m²/day, for example less than or equal to about 0.030 g/m²/day, less than or equal to about 0.025 g/m²/day, less than or equal to about 0.023 g/m²/day, less than or equal to about 0.022 g/m²/day, less than or equal to about 0.021 g/m²/day, less than or equal to about 0.020 g/m²/day, less than or equal to about 0.015 g/m²/day, or less than or equal to about 0.01 g/m²/day, but is not limited thereto.

Furthermore, the composite material including the polymer and the inorganic moisture absorber may include graphite in an amount of less than or equal to about 30 wt %, for example about 1 wt % to about 30 wt %, about 2 wt % to about 30 wt %, about 3 wt % to about 30 wt %, about 3 wt % to about 25 wt %, about 5 wt % to about 25 wt %, about 5 wt % to about 20 wt %, about 5 wt % to about 15 wt %, or about 5 wt % to about 10 wt % based on a total weight of the composite material. If the graphite is included within the amount ranges, the water vapor transmission rate of the battery case made therefrom may be further reduced.

The graphite may have a particle size of about 1 μm to about 100 μm, for example, about 5 μm to about 100 μm, about 10 μm to about 100 μm, about 15 μm to about 100 μm, about 20 μm to about 100 μm, about 25 μm to about 100 μm, or about 30 μm to about 100 μm, but is not limited thereto.

The graphite may have an aspect ratio, that is, a ratio of the longest diameter to the shortest diameter of greater than or equal to about 10, for example, greater than or equal to about 20, greater than or equal to about 30, greater than or equal to about 40, greater than or equal to about 50, greater than or equal to about 60, greater than or equal to about 70, greater than or equal to about 80, greater than or equal to about 90, greater than or equal to about 100, greater than or equal to about 110, greater than or equal to about 120, greater than or equal to about 130, greater than or equal to about 140, greater than or equal to about 150, greater than or equal to about 160, greater than or equal to about 170, greater than or equal to about 180, greater than or equal to about 190, or greater than or equal to about 200, but is not limited thereto.

The graphite having the aforementioned particle size and aspect ratio lengthens a permeation path of external moisture into the battery case and thereby provides a much larger path or route for the moisture from the external surface of the battery case into the internal surface, and thus has an effect of decreasing the water vapor transmission rate. A graphite having a high aspect ratio is regarded to have a larger effect of decreasing a water vapor transmission rate than graphite having a low aspect ratio. As described later, a battery case including expanded graphite having an aspect ratio of greater than or equal to about 100 exhibits a water vapor transmission rate of about 0.007 g/m²/day which is greatly decreased from about 0.022 g/m²/day, compared with a battery case including about 10 wt % of general graphite having an aspect ratio of about 50.

The composite material may further include materials conventionally known as a moisture-barrier material in addition to the graphite. Such a moisture barrier material may be, for example, a crystal of a polymer which may be the same or different as the polymer of a main material, a particle of an inorganic material different from the inorganic moisture absorbent, or a fiber-shaped material such as a glass fiber or a carbon fiber. Specific examples of the moisture barrier material may be wollastonite, mica, whisker, barium sulfate, kaolin, talc, nanoclay, a carbon fiber or a glass fiber having an aspect ratio of greater than or equal to about 100, or a mixture thereof, but are not limited thereto.

The battery case may be a battery case for a rechargeable lithium battery, but is not limited thereto. It may be a case for any battery that accommodates at least one electrode assembly and requires moisture transmission resistivity.

As described above, the battery case according to an embodiment includes at least one partition wall 7 in the sink 4 of the container 1, and the sink 4 may be partitioned into at least two compartments 8 by at least one partition wall 7.

When the battery case according to an embodiment has at least two compartments 8 in the sink, each of the at least two compartments 8 may accommodate one electrode assembly including a positive electrode and a negative electrode, and because the battery case has excellent moisture transmission resistivity, the electrode assembly may not be wrapped with an exterior material such as a metal pouch and the like, but may directly be introduced into each compartment 8 to form a battery. Accordingly, a battery with significantly reduced inflow of external moisture and air may be manufactured by housing an electrode assembly including positive and negative electrodes in the sink of the battery case according to an embodiment, additionally injecting an electrolyte solution thereinto, covering it with cover 5, and adhering the cover 5 to the container 1.

In addition, when the battery case includes at least two compartments 8 according to the embodiment, each electrode assembly including positive and negative electrodes may be respectively accommodated into each of the at least two compartments 8 to easily manufacture a battery module including a plurality of battery cells. Herein, a cell-module integrated battery including a plurality of battery cells may be easily manufactured by respectively introducing the electrode assembly into each compartment 8 in the battery case without being wrapping with a separate metal pouch and the like.

Conventionally, a battery module is manufactured by forming an electrode assembly including positive and negative electrodes, wrapping it with a metal pouch having moisture transmission resistivity to form a battery cell, and packing the battery cell with a metal battery case again, which can be a complex and long process, and therefore, high manufacturing costs.

As aforementioned, the battery case according to an embodiment may be used to easily manufacture a battery module including a plurality of battery cells as well as a battery including one battery cell into a cell-module integrated type and thus greatly reduce a cost and time during the manufacture of the battery or the battery module. In addition, the battery case includes a polymer as a primary material component and thus may be freely manufactured to have a light weight and a desired size and shape.

In an embodiment, the battery case may have a water vapor transmission rate of less than or equal to about 0.04 g/m²/day, measured at a thickness of about 1 mm and at about 38° C. under relative humidity of about 100% according to ISO 15106 or ASTM F1249. In particular, the water vapor transmission rate may be decreased down to about 0.03 g/m²/day by adjusting a type of a base polymer forming the battery case and/or a type and an amount of an inorganic moisture absorber. In addition, a water vapor transmission rate of a battery case manufactured by further including additional components such as the graphite and other moisture barrier materials may be decreased down to less than or equal to about 0.025 g/m²/day, for example less than or equal to about 0.020 g/m²/day, less than or equal to about 0.015 g/m²/day, or less than or equal to about 0.01 g/m²/day. Therefore, using a battery case according to an embodiment, a battery or a battery module such as a rechargeable lithium battery may be easily provided.

In general, an electrode assembly of the battery may include a positive electrode, a negative electrode and a separator disposed therebetween. The electrode assembly may further include, for example an aqueous non-aqueous electrolyte solution in the separator. The types of the electrode assembly are not particularly limited, but in an embodiment, the electrode assembly may include an electrode assembly for a rechargeable lithium battery. The positive electrode, the negative electrode, the separator, and the electrolyte solution of the electrode assembly may be desirably selected according to types of the electrode and are not particularly limited. A positive electrode, a negative electrode, a separator, and an electrolyte solution, each of which are well known to those skilled in the art may be used to form an electrode assembly. The manufactured electrode assembly is disposed in the battery case according to an embodiment, for example, in the sink 4 of the battery case or at least two compartments 8 in the sink, and then, an electrolyte solution may be injected into the sink 4, or the at least two compartments 8 in the sink, to easily manufacture a battery or a battery module.

The positive electrode may include, for example, a positive active material disposed on a positive current collector and may further include at least one of a conductive material and a binder. The positive electrode may further include a filler. The negative electrode may include, for example a negative active material disposed on a negative current collector and may further include at least one of a conductive material and a binder. The negative electrode may further include a filler.

The positive active material may include, for example a (solid solution) oxide including lithium but is not particularly limited as long as it is a material capable of intercalating and non-intercalating lithium ions electrochemically.

The positive active material may be a layered compound such as lithium cobalt oxide (LiCoO₂), lithium nickel oxide (LiNiO₂), and the like, a compound substituted with one or more transition metal; a lithium manganese oxide such as Chemical Formulae Li₁₊ₓMn₂₋ₓO₄ (wherein, x is 0 to 0.33), LiMnO₃, LiMn₂O₃, LiMnO₂, and the like; lithium copper oxide (Li₂CuO₂), vanadium oxide such as LiV₃O₈, LiFe₃O₄, V₂O₅, Cu₂V₂O₇, and the like; a Ni site-type lithium nickel oxide represented by Chemical Formula LiMn₂₋ₓMₓO₂ (wherein, M=Co, Mn, Al, Cu, Fe, Mg, B, or Ga and x=0.01 to 0.3); a lithium manganese composite oxide represented by Chemical Formula LiMn₂₋ₓMₓO₂ (wherein, M=Co, Ni, Fe, Cr, Zn, or Ta and x=0.01 to 0.1) or Li₂Mn₃MO₈ (wherein, M=Fe, Co, Ni, Cu, or Zn); LiMn₂O₄ where a part of Li of Chemical Formula is substituted with an alkaline-earth metal ion; a disulfide compound; Fe₂(MoO₄)₃, and the like, but is not limited thereto.

Examples of the conductive material may include carbon black such as ketjen black, acetylene black, and the like, natural graphite, artificial graphite, and the like, but is not particularly limited as long as it may increase conductivity of the positive electrode.

The binder may be for example, polyvinylidene fluoride, an ethylene-propylene-diene terpolymer, a styrene-butadiene rubber, an acrylonitrile-butadiene rubber, a fluorine rubber, polyvinyl acetate, polymethylmethacrylate, polyethylene, nitrocellulose, and the like, but is not particularly limited as long as it may bind the (positive or negative) active material and the conductive material on the current collector. Examples of the binder may be polyvinyl alcohol, carboxymethyl cellulose (CMC), starch, hydroxypropyl cellulose, recycled cellulose, tetrafluoroethylene, polyethylene, polypropylene, an ethylene-propylene-diene polymer (EPDM), sulfonated EPDM, a styrene-butadiene rubber, a fluorine rubber, various copolymers, polymeric highly saponified polyvinyl alcohol, and the like in addition to the foregoing materials.

The negative active material may be for example carbon and graphite materials such as natural graphite, artificial graphite, expanded graphite, carbon fiber, non-graphitic carbon, carbon black, carbon nanotube, fullerene, activated carbon, and the like; a metal such as Al, Si, Sn, Ag, Bi, Mg, Zn, In, Ge, Pb, Pd, Pt, Ti, and the like that may be an alloy with lithium and a compound including such an element; a composite material of a metal and a compound thereof and carbon and graphite materials; a lithium-containing nitride, and the like. Among them, carbon-based active materials, silicon-based active materials, tin-based active materials, or silicon-carbon-based active materials may be desirably used and may be used alone or in a combination of two or more.

The separator is not particularly limited and may be any separator of a rechargeable lithium battery. For example, a porous film or non-woven fabric having excellent high rate discharge performance may be used alone or in a mixture thereof. The separator may include pores and the pores may have generally a pore diameter of about 0.01 μm to about 10 μm and a thickness of about 5 μm to about 300 μm. A substrate of the separator may include, for example, a polyolefin-based resin, a polyester-based resin, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, and the like. If the electrolyte is a solid electrolyte such as a polymer, the solid electrolyte may function as a separator.

The conductive material is a component to further improve conductivity of an active material and may be included in an amount of about 1 wt % to about 30 wt % based on a total weight of the electrode, but is not limited thereto. Such a conductive material is not particularly limited as long as it does not cause chemical changes of a battery and has conductivity, and may be for example, graphite such as natural graphite or artificial graphite; carbon black such as carbon black, acetylene black, ketjen black, channel black, furnace black, lamp black, summer black, and the like; a carbon derivative such as carbon nanotube, fullerene, and the like, a conductive fiber such as a carbon fiber or a metal fiber, and the like; carbon fluoride, a metal powder such as aluminum, a nickel powder, and the like; a conductive whisker such as zinc oxide, potassium titanate, and the like; a conductive metal oxide such as a titanium oxide; a conductive material such as a polyphenylene derivative, and the like.

The filler is an auxiliary component to suppress expansion of an electrode, is not particularly limited as long as it does not cause chemical changes of a battery and is a fiber-shaped material, and may be for example, an olefin-based polymer such as polyethylene, polypropylene, and the like; a fiber-shaped material such as a glass fiber, a carbon fiber, and the like.

In the electrode, the current collector may be a site where electron transports in an electrochemical reaction of the active material and may be a negative current collector and a positive current collector according to types of the electrode. The negative current collector may have a thickness of about 3 μm to about 500 μm. The negative current collector is not particularly limited as long as it does not cause chemical changes of a battery and has conductivity and may be, for example, copper, stainless steel, aluminum, nickel, titanium, fired carbon, copper or stainless steel that is surface-treated with carbon, nickel, titanium, silver, or the like, an aluminum-cadmium alloy, and the like.

The positive current collector may have a thickness of about 3 μm to about 500 μm, but is not limited thereto. Such a positive current collector is not particularly limited as long as it does not cause chemical changes of a battery and has high conductivity and may be, for example, stainless steel, aluminum, nickel, titanium, fired carbon, or aluminum or stainless steel that is surface-treated with carbon, nickel, titanium, silver, or the like.

The current collectors may have a fine concavo-convex structure on its surface (or a roughened surface) to reinforce a binding force of the active material and may be used in various shapes of a film, a sheet, a foil, a net, a porous film, a foam, a non-woven fabric, or the like.

The lithium-containing non-aqueous electrolyte solution may include a non-aqueous electrolyte and a lithium salt.

The non-aqueous electrolyte may be, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxy furan, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and the like.

The lithium salt is a material that is dissolved in the non-aqueous electrolyte solution and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbFe, LiAICl₄, CH₃SO₃Li, CF₃SO₃Li, (CF₃S₀₂)₂NLi, lithium chloro borane, lower aliphatic lithium carbonate, lithium 4 phenyl borate, imide, and the like.

An organic solid electrolyte, an inorganic solid electrolyte, and the like may be used as needed.

The organic solid electrolyte may be, for example, polyethylene derivative, a polyethylene oxide derivative, a polypropylene oxide derivative, a phosphoric acid ester polymer, a poly agitation lysine, polyester sulfide, polyvinyl alcohol, polyvinylidene fluoride, a polymer including an ionic leaving group, and the like.

The inorganic solid electrolyte may be, for example, nitrides of Li such as Li₃N, LiI, Li₅Nl₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, and the like, halides, sulfates, and the like.

The non-aqueous electrolyte solution may include, for example, pyridine, triethylphosphite, triethanolamine, cyclic ether, ethylene diamine, n-glyme, hexaphosphoric tris-amide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride in order to improve charge and discharge characteristics, flame retardancy, and the like. As needed, in order to endow inflammability, a halogen-containing solvent such as carbon tetrachloride, ethylene trifluoride, and the like may be further added and in order to improve high temperature storage characteristics, carbon dioxide gas may be further added.

As described above, a battery or a battery module including a battery case according to an embodiment does not need manufacture of a unit cell including exterior materials having additional moisture transmission resistivity on the above electrode assembly, and thus the electrode assembly may be directly accommodated in the sink of the battery case without additional exterior materials.

As described above, the battery case according to an embodiment may be manufactured to have a desired size and shape and specifically, the container 1 and the cover 5 by molding a composite material including the polymer base material, for example, a polymer as a base material, an inorganic moisture absorber, and/or additional moisture barrier materials using well known molding methods in the art, for example, extrusion molding, injection molding, blow molding, press molding, and the like. Moreover, to safely protect an electrode assembly accommodated therein we describe forming a nanometer-size concavo-convex edge feature using a plasma surface treatment and the like where the molded container 1 and the molded cover 5 contact. The application of an adhesive where the container 1 and the cover 5 contact after placement of the electrode assembly in the battery case of the container 1, and bonding them to prevent or minimize permeation of external moisture or air and the like. In addition, if the electrode assembly accommodated in the sink 4 is an electrode assembly for a rechargeable lithium battery, the battery case including the electrode assembly may be used itself as a rechargeable lithium battery or a battery module.

Accordingly, the battery case according to an embodiment and the battery or the battery module including the same may be manufactured using an inexpensive material compared with a conventional battery case manufactured by using a metal, or produced more easily than a conventional battery or battery module including the conventional battery case. In addition, the manufactured battery case and battery or battery module are light and thus may exhibit high energy efficiency and also have excellent mechanical properties and moisture transmission resistivity and thus may replace the conventional metal battery case and the conventional battery or battery module including the metal battery case.

While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A battery case comprising a container having an opening and a sink configured to accommodate an electrode assembly, wherein the electrode assembly comprising a positive electrode and a negative electrode, and
a cover having a contact portion configured to contact with the container to cover the opening of the container,
wherein at least one of the container or the cover comprises a polymer base material,
the container comprises a bottom wall and side walls, the bottom wall and the side walls are integrated to form the sink and the opening opposed to the bottom wall, and
a nanometer size concavo-convex edge feature is positioned on at least one portion of an end face of the side walls configured to form the opening and on at least one portion of the contact surface of the contact portion of the cover configured to contact at least one portion of the end face.

2. The battery case of claim 1, wherein the nanometer-size concavo-convex edge feature is formed by plasma treatment.

3. The battery case of claim 1, wherein the plasma treatment is performed in the presence of argon, oxygen, or a mixture thereof.

4. The battery case of claim 1, wherein the nanometer-size concavo-convex edge feature has a ratio of a depth with reference to a width of greater than or equal to 20 percent.

5. The battery case of claim 1, wherein the nanometer-size concavo-convex edge feature has a width of about 10 nanometers to about 100 nanometers and a depth of about 2 nanometers to about 50 nanometers.

6. The battery case of claim 1, wherein the at least one portion of the end face of the side walls or the at least one portion of the contact surface of the contact portion of the cover configured to contact at least one portion of the end face has a water contact angle of less than about 5 degrees.

7. The battery case of claim 1, further comprising a millimeter-size recess portion and corresponding protrusion configured to engage each other and positioned on at least one portion of the end face of the side walls configured to form the opening and on at least one portion of the contact surface of the contact portion of the cover configured to contact at least one portion of the end face.

8. The battery case of claim 7, wherein the millimeter-size recess portion and corresponding protrusion have a right triangular shape in their vertical cross-section, wherein the recess portion proximate to the sink recedes perpendicularly into the side walls to a set depth and has a depth that gradually decreases from the set depth as it goes nearer to the outsides of the container to form an oblique shape in the vertical cross-section, and wherein the corresponding protrusion has a shape corresponding to the recess portion to engage each other.

9. The battery case of claim 8, wherein a nanometer-size concavo-convex edge feature is positioned on an oblique surface of the recess portion and/or an oblique surface of the corresponding protrusion.

10. The battery case of claim 1, wherein the container further comprises at least one partition wall that divides the inside of the sink into two or more spaces.

11. The battery case of claim 1, wherein the polymer base material comprises a polymer comprising polycarbonate, polyethylene, polypropylene, polyvinyl, polyamide, polyester, polyphenylene sulfide, polyphenylene ether, polyphenylene oxide, polystyrene, polyamide, a polycyclic olefin copolymer, an acrylonitrile-butadiene-styrene copolymer, a liquid crystal polymer, a mixture thereof, an alloy thereof, or a copolymer thereof.

12. The battery case of claim 11, wherein the polymer base material further comprises an inorganic moisture absorber dispersed in the polymer base material, the inorganic moisture absorber comprising a silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂), Ba(ClO₄)₂, Ca, or a combination thereof.

13. The battery case of claim 11, wherein the polymer base material further comprises a moisture barrier material dispersed in the polymer base material, the moisture barrier material comprising graphite, wollastonite, mica, whisker, barium sulfate, kaolin, talc, nanoclay, a carbon fiber, a glass fiber, or a mixture thereof.

14. The battery case of claim 1, wherein the container and the cover are made by a molding process, and each include the same or a different polymer base material.

15. The battery case of claim 1, wherein the battery case has a water vapor transmission rate of less than 0.05 gram per square meter per day measured at a thickness of 1 millimeter, at 38° C. under relative humidity of 100% according to ISO 15106 or ASTM F1249.

16. A battery comprising
the battery case of claim 1, and
an electrode assembly comprising a positive electrode and a negative electrode and being accommodated in a sink of the battery case.

17. The battery of claim 16, wherein the battery further comprises an electrolyte solution in the sink.

18. The battery of claim 16, wherein the electrode assembly is for a rechargeable lithium battery.

19. The battery of claim 16, wherein the container and the cover of the battery case are adhered to one another with an adhesive.
